(19) United States
(12) Patent Application Publication
(10) Pub. No.: US 2004/0227086 A1
(43) Pub. Date: Nov. 18, 2004

(54) Method and device for NIR reflection spectroscopy

(75) Inventors: Holger Gerhard Haug, Sandwich (GB); Alexander Pysik, Sandwich (GB)

Correspondence Address: PFIZER INC., PATENT DEPARTMENT, MS8260-1611, EASTERN POINT ROAD, GROTON, CT, 06340, US

(73) Assignee: Pfizer Inc

(21) Appl. No.: 10/794,254

(22) Filed: Mar. 4, 2004

Related U.S. Application Data
(60) Provisional application No. 60/452,824, filed on Mar. 7, 2003.

(51) Int. Cl. G01N 21/35

(52) U.S. Cl. 250/339.07

(57) ABSTRACT

A method and a device for the analysis of products in the form of a capsule, and of empty capsules, by means of NIR reflection spectroscopy are provided wherein the capsule is rotated around at least one axis during the recording of the reflection spectrum. Means for rotating the capsule are also provided.

This application claims priority to U.S. Provisional Application Ser. No. 60/452,824, filed Mar. 7, 2003.

### BACKGROUND OF THE INVENTION

The invention provides a method and device for the analysis of products in the form of a capsule and of empty capsules by means of NIR reflection spectroscopy.

NIR reflection spectroscopy is employed in pharmacy amongst others to analyse capsules and the content of capsules. It enables both the physical and chemical properties of the capsules to be determined. These include, in particular, the particle size, water content, identity, or content of actives. Compared with chemical processes such as chromatography, NIR spectroscopy has the advantage that the sample, in most cases, does not have to be destroyed for the analysis and the gain of time because no or only minimal sample preparation is necessary.

The state of the art recognises methods and devices for NIR reflection spectroscopy on capsules in which the capsules are arranged at a fixed location. However, only a small part of the capsule case and contents can be measured when the capsules are in fixed positions. The distribution of the capsule contents in the capsule and the spread is not known in advance and is neither taken into consideration nor determined in the measurement. It may, therefore, be the case that, if the capsule is not completely full, the capsule contents are located only at one end of the capsule. If measurement is restricted to the middle of the capsule, the capsule contents are not captured in the measurement.

### SUMMARY OF THE INVENTION

In contrast, the method and device of the invention have the advantage that the rotation of the capsule during the measuring process ensures that several readings are obtained which yield a mean value in respect of the spread and density of the capsule contents. Should the capsule contents be located only at one end of the capsule at the start of measurement, they are distributed over the entire capsule through the rotation. Non-reproducible conditions of the capsule contents in respect of the distribution within the capsule are thus balanced out. Furthermore, a large part of the capsule case can be captured with one measurement.

According to a preferred embodiment of the invention, the capsule is arranged horizontally and rotated around its longitudinal axis. To this end, the device has two jaws between which the capsule is fixed. At least one of the two jaws is brought into rotation by means of a rotary drive. This rotating movement is transmitted to the capsule and the second jaw. The rotation around the longitudinal axis of the horizontally arranged capsule has the advantage that the capsule contents are distributed over the entire capsule and do not slide from one end of the capsule to the other. The fixed location of the spectrometer also ensures that a large part of the capsule case is captured.

There is the further possibility that the capsule is arranged vertically or at any desired angle and that it is then rotated around axes perpendicular to the longitudinal axis.

In place of reflection, the transmission of the NIR can also be determined and evaluated with the method and device of the invention. The capsule mounting does not completely enclose the capsule, thereby allowing transmission of the NIR.

Further advantages and advantageous configurations of the invention can be obtained from the following description, the drawing and the claims.

### DRAWINGS

The drawings show an exemplary embodiment of a device according to the invention which is described in detail hereinbelow.

FIG. 1 Capsule mounting with rotary drive, partial perspective cross-section view

FIG. 2 Pin mounting, front view

### REFERENCE NUMERALS

1 Capsule mounting

2 Rotary drive

3 Jaw

4 Jaw

5 Receptacle

6 Receptacle

7 Pin

8 Pin

9 Pin mounting

10 Tubular section of the pin mounting

11 Plate-shaped section of the pin mounting

12 Recess for pin

13 Recess for pin

14 Helical spring

15 Gear wheel

16 Gear wheel

17 Gear wheel

18 Front side

19 Capsule

20 Gear Box

A Beam Axis of NIR

B Longitudinal Axis of Capsule and Receptacles

### DETAILED DESCRIPTION OF THE INVENTION

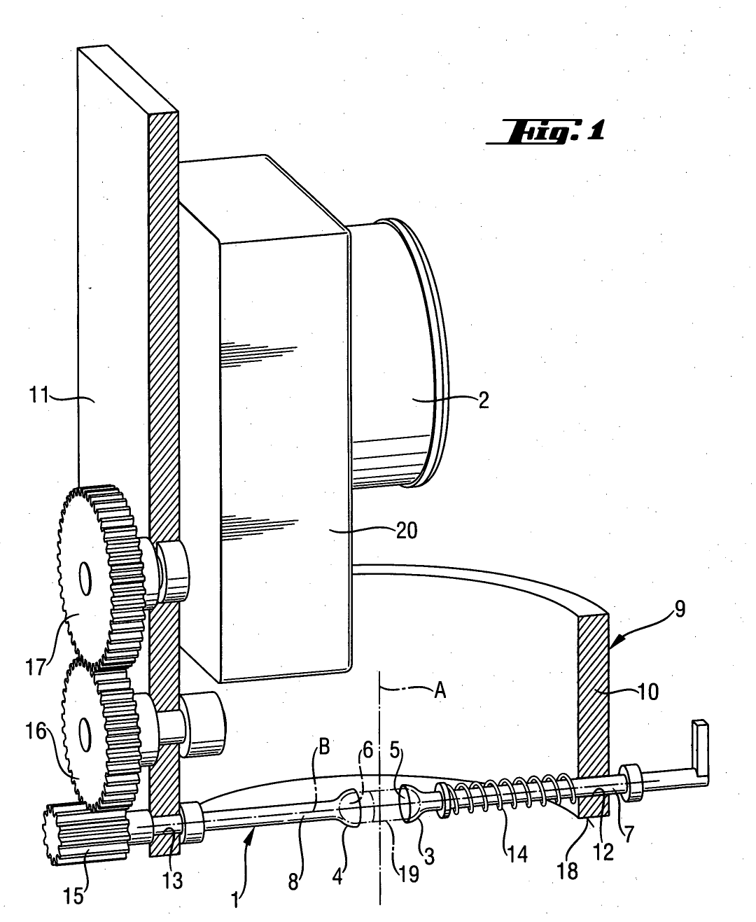

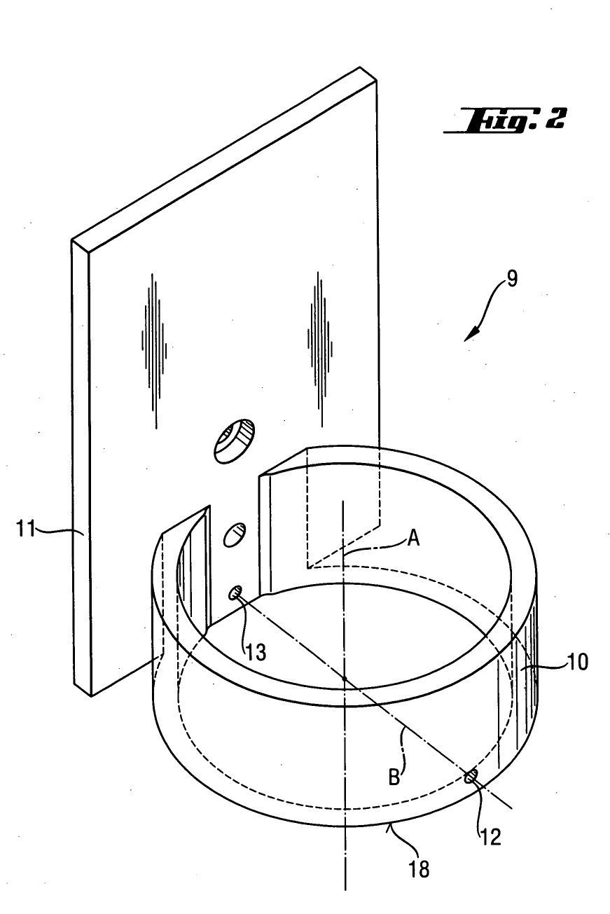

FIG. 1 shows a capsule mounting means 1 with rotary drive 2 in partial perspective, cross-section, view. The capsule mounting means essentially consists of two jaws 3 and 4 which have a hollow receptacle 5 and 6 for accommodating a capsule 19, illustrated in outline. Each of the two jaws 3 and 4 is secured to a pin 7 and 8. The pin 7 is movably located in a pin mounting 9. The pin mounting 9 is shown in FIG. 2 and consists of a tubular section 10 and a plate-shaped section 11. The tubular section 10 of the pin mounting 9 has recesses 12 and 13 adapted to the pins for the purpose of guiding the two cylindrical pins 7 and 8. Around pin 7 is stretched a helical spring 14 which is fixed between the jaw 3 and the pin mounting 9. The helical spring 14 is pressed together by the clamping of a capsule 19 between the two jaws 3 and 4. The resulting spring force of the helical springs ensures that the capsule 19 is clamped between the two jaws 3 and 4. The pin 8 has a gear wheel 15 at the end projecting out of the pin mounting 9. The gear wheel 15 is connected to the rotary drive 2 by means of two further gear wheels 16 and 17. The gearing consisting of the gear wheels 15, 16, and 17 transmits the rotation of the rotary drive 2 to the pin 8 and thus to the capsule 19. The pin 7 is pivoted in the pin mounting 9 and is moved by the rotation of the capsule 19. A suitable rotary drive 2 may comprise an electric motor with gear, for instance. However, there is also the possibility of initiating the rotation manually by means of a handle or a crank, not shown in the drawing.

The capsule mounting means is placed with its front side 18 on an NIR spectrometer for the purpose of conducting the measurements. The beam axis A of the NIR runs perpendicular to the longitudinal axis B of the capsule 19. Since the two jaws 3 and 4 cover only a small part of the capsule, almost the entire capsule is captured by the NIR. Because of the rotation of the capsule 19 around its longitudinal axis B, almost the entire surface of the capsule and the entire capsule contents can be analysed.

All features of the invention can be material to the invention both individually and in any combination.

1. A method for the analysis of products in the form of a capsule, and of empty capsules, by means of NIR reflection spectroscopy, wherein the capsule is rotated around at least one axis during the recording of the reflection spectrum.

2. A method according to claim 1, wherein the capsule is arranged horizontally and rotated around its longitudinal axis.

3. A device for the analysis of products in the form of a capsule, and of empty capsules, by means of NIR reflection spectroscopy, the device comprising:
an NIR spectrometer and
means for mounting the capsule,
wherein the means for mounting the capsule is pivoted and a rotary drive is provided for rotating the capsule mounting means around at least one axis.

4. A device according to claim 3, wherein the capsule mounting means comprises two jaws, each jaw having a cavity facing the capsule in the mounted state for the accommodation of one end of the capsule.

5. A device according to claim 4, further comprising a spring which presses the two jaws together.

6. A device according to claim 4, wherein each of the two jaws is arranged on a pin.

7. A device according to claim 6, further comprising a pin mounting, wherein one of the two pins is axially movably mounted, and a helical spring fixed between one of the two jaws and the pin mounting.

8. A device according to claim 7, wherein a rotary drive is connected to at least one of the two pins.

9. A device according to claim 8, wherein the rotary drive is connected to at least one of the two pins by means of a toothed gearing.
